(19) United States
(12) Patent Application Publication
(10) Pub. No.: US 2011/0248563 A1
(43) Pub. Date: Oct. 13, 2011

(54) OPERATING ARRANGEMENT FOR AN ELECTRICALLY OPERATED VEHICLE

(75) Inventors: Thomas Komma, Ottobrunn (DE); Kai Kriegel, München (DE); Jurgen Rackles, Puchheim (DE)

(73) Assignee: Siemens Aktiengesellschaft, München (DE)

(21) Appl. No.: 12/998,938

(22) PCT Filed: Dec. 9, 2009
(86) PCT No.: PCT/EP2009/066688

§ 371 Date: Jun. 17, 2011

(30) Foreign Application Priority Data
Dec. 17, 2008 (DE) 10 2008 063.4

(51) Int. Cl. B60L 1/00

(52) U.S. Cl. 307/9.1

(57) ABSTRACT

For a battery, converter circuit, and electric motor in an electrically operated vehicle, the converter circuit is used to charge the battery from the power grid. The converter circuit is operated in such a way that the voltage in the intermediate circuit is at least 650 V and a sinusoidal current draw is ensured.

### CROSS REFERENCE TO RELATED APPLICATIONS

This application is the U.S. national stage of International Application No. PCT/EP2009/066688, filed Dec. 9, 2009 and claims the benefit thereof. The International Application claims the benefits of German Application No. 102008063465.4 filed on Dec. 17, 2008, both applications are incorporated by reference herein in their entirety.

### BACKGROUND

Described below are an operating arrangement of a battery, converter and electric motor, for an electrically operated vehicle and an operating method for an arrangement of this kind.

In modern electrically operated or hybrid vehicles, in particular those for road use, such as passenger cars or heavy goods vehicles, a rechargeable battery is provided as an additional car battery, the rechargeable battery storing electrical energy for drive purposes. The battery is connected to a converter which converts the single-phase battery voltage into a three-phase voltage for the electric motor or motors which is/are connected.

The battery of an electrically operated vehicle has to be connected to an external power supply system, usually the normal electricity supply system, in order to be recharged. In this case, it is desirable to enable a connection that is as simple and flexible as possible and at the same time to be able to use the highest possible power for charging the battery.

### SUMMARY

An operating arrangement for an electrically operated vehicle has a simplified design for charging the battery from an external electricity supply system.

The electrically operated vehicle has a battery for storing electrical energy, for example with lithium ion elements. A converter circuit with an intermediate circuit capacitor is also provided. The converter circuit is connected to the battery at the intermediate circuit capacitor ends. A three-phase electric motor may also provided. The electric motor is connected to the three-phase output end of the converter. Finally, there is a control device for controlling the converter circuit. The operating arrangement is designed to operate the converter such that the voltage across the intermediate circuit capacitor is at least 650 V.

A converter in an electrically operated vehicle having a battery and at least one electric motor is operated as an inverter for feeding power to the electric motor from the battery in a motor operating state. The converter is also operated as a rectifier for charging the battery from an external 3-phase power supply system in a charging operating state. In this case, the converter is operated such that the voltage in the intermediate circuit of the converter is at least 650V. The converter may be operated in a known manner as a rectifier for charging the battery in a recovery operating state.

In other words, the converter, which serves primarily for operating the electric motor or the electric motors from the battery which provides energy storage, is therefore used as a charging rectifier at the same time. As a result, there is advantageously no need to provide a separate rectifier, for example externally. Therefore, the vehicle can be connected to any three-phase external power supply without a special charging device being required for connection purposes. The intermediate circuit voltage, which is set at least 650 V, makes it possible to provide reliable operation from a three-phase external electricity supply system, that is to say in particular from the general electricity supply system, for example the domestic power supply. In particular, uncontrolled charging of the intermediate circuit via the free-wheeling diodes of the converter, which would lead to upstream fuses being tripped, is avoided.

Connection to the three-phase supply system also furthermore advantageously permits an improved capacity for recovery from the battery to the connected power supply system. Purely electrically operated vehicles are expected to be very widespread in the future. The number of active vehicles may then be in the order of magnitude of 60 million in Germany for example, with the vehicles naturally containing a corresponding number of batteries. These batteries generally have to be charged for a relatively long period of time in the range of several hours. Given a sufficient level of capacity for recovery, the batteries would be suitable for compensating for peak electrical loads.

The method described herein can be applied to purely electrically operated vehicles such as cars and heavy goods vehicles or buses, but also to hybrid vehicles having an additional internal combustion engine. The electric motor can be an asynchronous machine or a synchronous machine, in particular a permanent-magnet synchronous machine, for example in the field-weakening mode of operation.

According to one refinement, the converter is operated as a step-down controller. However, it is advantageous for the converter to be operated as a step-up controller. It is particularly advantageous for the converter to be operated such that it exhibits sinusoidal power consumption, that is to say with power factor correction (PFC).

To this end, it is advantageous for the turns of the electric motor to be used for power factor correction. As a result, additional inductors for power factor correction can especially be dispensed with or at least designed to be smaller. In this case, it is expedient for the motor to be stopped by a brake in order to prevent undesired movements. A switching device may be provided in this connection method. The switching device permits connection of the external power supply to the turns of the motor. In this case, the switching device ensures disconnection of the star point.

As an alternative, the external power can also be supplied between the motor and the converter. A switching device which switches over the phase lines between the motor and the external power supply is provided in this case too, that is to say the electric motor is decoupled from the converter in the charging operating state.

In both cases, the switching device permits disconnection of the electric motor and converter, for example for operation of the electric motor as a synchronous machine in the field-weakening mode of operation in the event of a fault. At the same time, this ensures a protective measure which would otherwise have to be provided in addition—for example in the form of a voltage protection module (VPM).

It is expedient for the semiconductor components which are used in the converter to have a dielectric strength of at least 1200 V. In modern electrically operated vehicles having an intermediate circuit voltage of only 400 V, the semiconductor components have a dielectric strength of, for example, approximately 600 V. In this case, the battery is also usually designed for an intermediate circuit voltage of substantially less than 650 V. In order, for example, to also be able to use a battery of this kind at the intermediate circuit voltage which is increased, a DC/DC converter, for example a step-down controller or a step-up controller, can be provided between the converter and the battery.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a block diagram of an arrangement including a synchronous motor, converter and battery,

FIG. 2 is a block diagram of a second arrangement including a synchronous motor, converter and battery,

FIG. 3 is a block diagram of a third arrangement including a synchronous motor, converter, DC/DC converter and battery.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

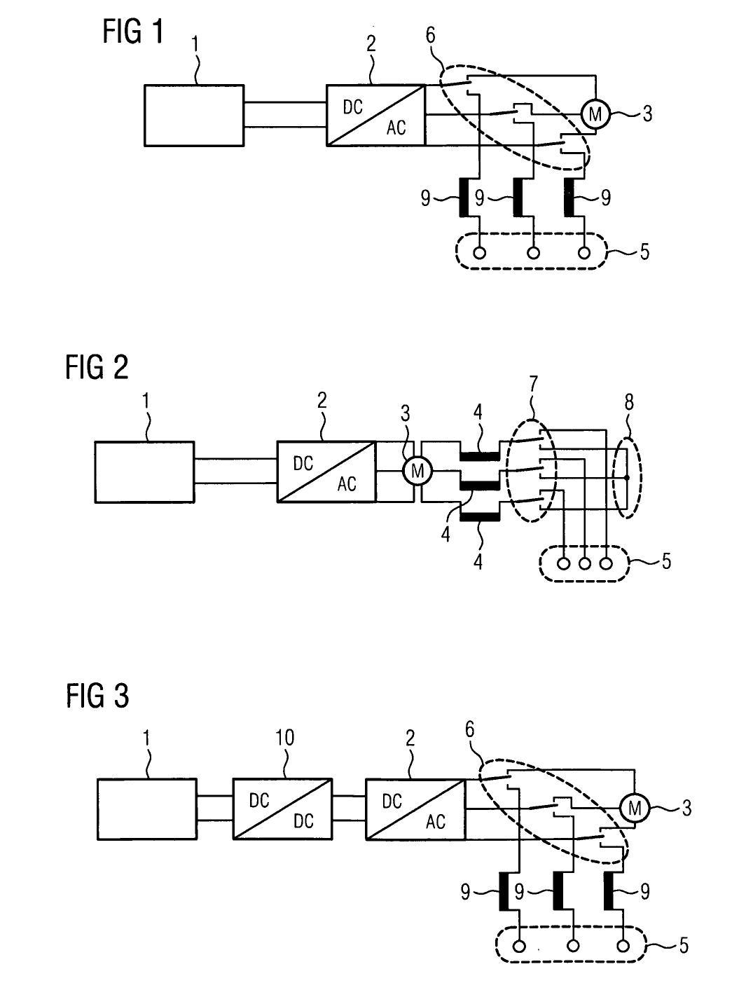

FIGS. 1 to 3 show structural parts according to a first to a third exemplary embodiment. In this case, the structural parts are several elements together. For example, in this case, a battery 1 is connected to a converter 2 via two electrical lines, directly in the case of FIGS. 1 and 2 or indirectly in FIG. 3. In this case, the converter 2 has, at the battery 1 end, an intermediate circuit capacitor (not shown in FIGS. 1 to 3).

The converter 2 is also connected to a permanent-magnet synchronous machine 3 via its three output lines. In this case, a switching device 6, 7 is provided between the converter 2 and the permanent-magnet synchronous machine 3. In this case, the switching devices each includes three switches, one for each of the three phase lines.

In FIG. 1, the switching device 6 can break the connection between the converter 2 and the permanent-magnet synchronous machine 3 for each of the phases. If the connection is broken, a connection is simultaneously established from the converter 2 to a three-phase supply system connection 5. The permanent-magnet synchronous machine 3 is then no longer electrically connected to the parts under consideration here. An inductor 9, which is used for power factor correction, is provided in each of the phase connections to the supply system connection 5. As a result, power is drawn from the power supply system, which is connected to the supply system connection 5, in a sinusoidal fashion. In this case, the inductor can be provided in the vehicle, but also outside the vehicle as part of a charging station.

The first exemplary embodiment, along with the other exemplary embodiments, permits operation in three different states. In the first state, the motor operating state, the permanent-magnet synchronous machine 3 is operated in a known manner by the battery 1, with the converter ensuring conversion of the single-phase DC voltage from the battery 1 into a three-phase AC voltage for the permanent-magnet synchronous machine 3. In this case, according to the first exemplary embodiment, the switching device 6 is expediently set such that the connection to the supply system connection 5 is broken and a connection is established between the converter 2 and the permanent-magnet synchronous machine 3.

In a second operating state, the recovery mode of operation, electrical energy is recovered from the permanent-magnet synchronous machine 3 to the battery in a known manner, this usually occurring during braking of the vehicle. In this case, the switching device 6 is likewise set in the same way as in the first operating state, that is to say there is no connection to the supply system connection 5.

A third operating state is the charging operating state. In this state, the battery 1 is charged from an external power supply system, usually the domestic supply system. This state exhibits a modified state of the switching device 6, in which state the connection between the converter 2 and the permanent-magnet synchronous machine 3 is broken. Instead, the converter 2 is connected to the supply system connection 5. In this case, the converter 2 acts as a step-up controller. In this case, it is controlled such that it generates a DC voltage of 680 V in its intermediate circuit, that is to say at the battery 1 end.

This DC voltage is advantageous since it is clearly above the peak voltage in any electricity network which has a three-phase voltage of 400 V+/−15%. In a supply system of this kind, the peak voltage can be up to 400 V·1.15·√2=650 V.

If the intermediate circuit voltage is below this voltage, it may lead to uncontrolled charging of the intermediate circuit via the free-wheeling diodes of the converter 2, and this would again trip fuses in the external supply system.

If the permanent-magnet synchronous machine 3 is operated in the field-weakening mode, the switching device 6 can be used to break the connection between the permanent-magnet synchronous machine 3 and the converter 2 if, for example, the converter 2 malfunctions. A malfunction of this kind is primarily a problem when the permanent-magnet synchronous machine 3 is moving. Since this is usually expected only when the vehicle is not connected to an external power supply system at the same time, a connection is not usually established from the converter 2 to the power supply system when the switching device 6 is switched over, the switch-over then corresponding only to disconnection of the connection between the permanent-magnet synchronous machine 3 and the converter 2.

FIG. 2 shows a second exemplary embodiment. The switching device 7 used here corresponds in terms of design to the switching device 6, but is arranged differently. The switching device 7 is arranged such that it can now establish a connection from the turns 4 of the motor to the star point 8, for example for the motor operating state or the recovery operating state. The connection from the turns 4 of the motor to the star point 8 can again be broken for the charging operating state. Instead, the switching device 7 establishes a connection from the three phase lines to the supply system connection 5. In this exemplary embodiment, the turns 4 of the motor are also used for power factor correction. As a result, the inductors 9 additionally used in the first exemplary embodiment can be omitted or at least smaller inductors can be used. In this case, the permanent-magnet synchronous machine 3 is expediently stopped by a brake (not shown in FIG. 2) in order to prevent unintentional movements.

In the second exemplary embodiment too, the converter 2 is designed to maintain an intermediate circuit voltage of at least 650 V, for example 700 V, and to operate as a step-up controller with sinusoidal current consumption.

The third exemplary embodiment according to FIG. 3 corresponds again to the first exemplary embodiment in terms of design of the switching device 6. One difference from the first exemplary embodiment is that, in the third exemplary embodiment, a DC/DC converter 10 is now provided between the converter 2 and the battery 1. In the third exemplary embodiment too, the converter 2 is designed to maintain an intermediate circuit voltage of at least 650 V, for example 720 V, and to operate as a step-up controller with sinusoidal current consumption. However, the intermediate circuit voltage reaches only as far as the DC/DC converter 10 in the third exemplary embodiment. The DC/DC converter converts the intermediate circuit voltage into a different DC voltage, 400 V in the third exemplary embodiment. As a result, it is possible to use a battery 1 which is designed for an intermediate circuit voltage of 400 V. The DC/DC converter 10 therefore makes the battery 1 independent of the intermediate circuit voltage.

It is clear that the use of the DC/DC converter 10 and the positioning of the switching devices 6, 7, that is to say the choice of whether the turns 4 of the motor should also be used or not, are independent of one another. To this extent, a fourth exemplary embodiment (not illustrated in any figure) can also proceed from the design according to the second exemplary embodiment and a DC/DC converter 10 can also be used here.

The design of the converter 2 corresponds to a known converter 2, especially a converter 2 for electrically operated vehicles, in terms of the interconnection of the elements. However, since an intermediate circuit voltage of at least 650 V is used, the semiconductor components which are conventionally used for a converter 2 in an electrically operated vehicle and have dielectric strengths of up to 600 V—at intermediate circuit voltages of up to 400 V—may not suffice. Instead, the semiconductor components have a dielectric strength of 1200 V in this case.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-7. (canceled)

8. An operating arrangement for an electrically operated vehicle having
a battery for storing electrical energy;
a converter circuit with an intermediate circuit including a capacitor;
at least one electric motor; and
a control device controlling the converter circuit to have a voltage in the intermediate circuit of at least 650 volts.

9. The operating arrangement as claimed in claim 8, wherein the converter circuit includes semiconductor components with a dielectric strength of at least 1200 volts.

10. The operating arrangement as claimed in claim 8, further comprising a DC/DC converter between the intermediate circuit and the battery.

11. A method for operating a converter circuit in an electrically operated vehicle having a battery and at least one electric motor, comprising:
operating the converter circuit as an inverter feeding power to the electric motor from the battery in a motor operating state; and
operating the converter circuit as a rectifier charging the battery from an external three-phase power supply system in a charging operating state.

12. The method as claimed in claim 11, wherein the converter circuit includes an intermediate circuit operated with a voltage of at least 650 volts.

13. The method as claimed in claim 12, wherein said operating of the converter circuit in the charging operating state is as a step-up controller.

14. The method as claimed in claim 13, wherein said operating of the converter circuit in the charging operating state is with sinusoidal power consumption.

15. The method as claimed in claim 11, wherein said operating of the converter circuit in the charging operating state is as a step-up controller.

16. The method as claimed in claim 15, wherein said operating of the converter circuit in the charging operating state is with sinusoidal power consumption.
